(19) United States
(12) Patent Application Publication
(10) Pub. No.: US 2025/0198465 A1
(43) Pub. Date: Jun. 19, 2025

(54) TAPERED ADAPTER FOR ROTATABLE ASSEMBLY AND ASSOCIATED METHOD

(71) Applicant: HORTON, INC., Roseville, MN (US)

(72) Inventors: William Remick, Chaska, MN (US); Cody Wentzel, Bloomington, MN (US)

(21) Appl. No.: 18/849,666

(22) PCT Filed: Mar. 15, 2023
(86) PCT No.: PCT/US2023/064370

§ 371 Date: Sep. 23, 2024

Related U.S. Application Data
(60) Provisional application No. 63/269,874, filed on Mar. 24, 2022.

(51) Int. Cl. F16D 1/096; F04D 25/02; F04D 25/08; F04D 29/26; F04D 29/64; F16D 1/06

(52) U.S. Cl. CPC F16D 1/096; F04D 25/022; F04D 29/263; F04D 29/646; F04D 25/08; F16D 2001/062

(57) ABSTRACT

A kit for use with a drivetrain of a rotatable assembly includes a tapered bushing, a tapered adapter, and a bushing lock. The tapered bushing includes a flange, a sleeve portion, a central opening, a keyway located along the central opening, at least one fastener hole, and a tapered mating surface facing outward. The tapered adapter includes a hub body with an end face portion, an interior cavity, a threaded shaft, at least one fastener hole extending substantially axially through the hub body, and a tapered mating surface facing inward. The fastener hole(s) of the tapered adapter and tapered bushing are configured to align. The bushing lock includes a bushing lock central opening extending axially, a keyway located along the bushing lock central opening, and a fastener hole extending substantially radially.

### FIELD

The present invention relates to a rotatable assembly, an adapter kit for use in such a rotatable assembly, a tapered adapter for use in such an adapter kit and/or rotatable assembly, as well as methods of making and using such a tapered adapter, adapter kit, and rotatable assembly.

### BACKGROUND

Many applications, including some vehicular applications, utilize alternating current (AC) electric motors with a fan to cool a radiator, rather than a gas or diesel engine. One disadvantage to an AC electric motor, however, is that it normally runs at a constant speed. In order to vary fan speed, a variable frequency drive (VFD) must be added to the system. Because the overall cost of adding a VFD to an AC electric motor is so high, alternative options are being investigated. One such option is to add an electronically-controlled viscous fan clutch to the electric motor, which allows full variability of fan speed while maintaining constant motor speed.

Therefore, it is desired to provide a mechanism for connecting a clutch to an output shaft of the type typically found on electric motors, preferably allowing for selectable assembly of a drivetrain between a motor and a fan in either a variable-drive configuration (using a clutch) or a direct-drive configuration (without a clutch) in a relatively easy manner.

### SUMMARY

In one aspect, a kit for a drivetrain of a rotatable assembly with an output shaft having a key can include a tapered bushing, a tapered adapter, and a bushing lock. The tapered bushing can include a flange, a sleeve portion, a central opening, a keyway located along the central opening, and at least one fastener hole in the flange. The sleeve portion can have a tapered mating surface facing outward. The tapered adapter can include a hub body, an interior cavity, a threaded shaft extending axially forward from a center of an end face portion of the hub body opposite the interior cavity, at least one fastener hole extending substantially axially through the hub body, and a tapered mating surface located along the interior cavity and facing inward. The respective tapered mating surfaces of the tapered bushing and the tapered adapter are configured to be engageable with each other. The at least one fastener hole of the tapered adapter and the at least one fastener hole of the tapered bushing are configured to align to engage at least one fastener therebetween when the respective tapered mating surfaces of the tapered bushing and the tapered adapter are engaged. The bushing lock can include a bushing lock central opening extending axially, a keyway located along the bushing lock central opening, and a fastener hole extending substantially radially. The bushing lock is configured to be securable on the output shaft adjacent to the tapered bushing.

In another aspect, a method of making a rotatable assembly includes engaging a tapered bushing with an output shaft such that a keyway of the tapered bushing engages a key of the output shaft, engaging a bushing lock on the output shaft adjacent to the tapered bushing such that a keyway of the bushing lock engages the key of the output shaft, securing the bushing lock to the output shaft against axial movement, engaging a tapered adapter with the tapered bushing such that a tapered mating surface of the tapered adapter engages a tapered mating surface of the tapered bushing, and engaging a fastener between the tapered adapter and the tapered bushing.

In another aspect, a rotatable assembly providing a drivetrain to transmit torque from an output shaft having a key and being rotatable can include a tapered bushing, a tapered adapter, and a bushing lock. The tapered bushing can include a flange, a sleeve portion, a central opening, and a keyway. The sleeve portion of the tapered bushing can have a tapered mating surface facing outward. The output shaft can be arranged in the central opening of the tapered bushing, and the key can be engaged with the keyway. The tapered adapter can include a hub body with an end face portion, an interior cavity, a threaded shaft extending axially forward from a center of the end face portion opposite the interior cavity, and a tapered mating surface located along the interior cavity and facing inward. The respective tapered mating surfaces of the tapered bushing and the tapered adapter can be engaged with each other, and the flange of the tapered bushing and the hub body of the tapered adapter can be secured together with a fastener. The bushing lock can include a bushing lock central opening in which the output shaft is arranged, a keyway engaged with the key, and a fastener hole extending substantially radially with a fastener engaged with the output shaft and the fastener hole in the bushing lock. The bushing lock can be positioned adjacent to the tapered bushing such that the tapered bushing is axially retained on the output shaft.

In yet another aspect, a tapered adapter for a rotatable assembly can include a hub body that is continuous in a circumferential direction, an interior cavity, a threaded shaft, and at least one fastener hole. The hub body can include an axially-extending portion having a cylindrical shape, an end face portion extending radially and located at a distal end of the axially-extending portion, and a tapered mating surface facing inward and having a frusto-conical shape. The interior cavity can be bounded by both the axially-extending portion and the end face portion and can have a rear face that is open opposite the end face portion. The tapered mating surface can be located along the interior cavity. The threaded shaft can extend axially forward from a center of the end face portion of the hub body opposite the interior cavity and aligned with an axis of rotation of the tapered adapter. The threaded shaft can be the only portion of the tapered adapter that has threads that encircle the axis of rotation. The at least one fastener hole can extend substantially axially and can pass entirely through the axially-extending portion of the hub body.

The present summary is provided only by way of example, and not limitation. Other aspects of the present invention will be appreciated in view of the entirety of the present disclosure, including the entire text, claims, and accompanying figures.

### BRIEF DESCRIPTION OF THE DRAWINGS

FIG. 1A is a side elevation view of a drivetrain of a rotatable assembly.

FIG. 1B is a front perspective view of the rotatable assembly of FIG. 1A shown without a fan.

FIG. 2 is a cross-sectional view of a portion of the rotatable assembly of FIGS. 1A and 1B.

FIG. 3A is a cross-sectional perspective view of a portion of the rotational assembly, and FIG. 3B is another cross-sectional view of the same portion of the rotational assembly. FIGS. 3A and 3B are taken at a different sectional plane than FIG. 2, and the clutch is not shown in FIGS. 3A and 3B.

FIG. 4 is a front perspective view of a tapered adapter.

FIGS. 5A and 5B are cross-sectional views of an alternate embodiment of a rotational assembly with a directly-driven configuration.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DETAILED DESCRIPTION OF ILLUSTRATIVE EMBODIMENTS

Embodiments of a rotatable assembly with a tapered adapter, and an associated adapter kit and method of making and using the same, are disclosed herein. The disclosed assembly and tapered adapter allow a clutch to be installed onto an output shaft of an electric motor, which allows an output device such as a fan to be driven at variable speeds. Further, in some embodiments, the adapter kit allows for either directly coupling a fan (or other output device) to the output shaft of the motor (without a fan clutch) or connecting a clutch between the motor and the fan (or other output device), thereby allowing flexibility and relatively easy changeovers. For example, an embodiment of an adapter kit can provide a tapered bushing that can be used to mount a tapered hub of a fan to the electric motor in a direct-drive configuration, and a tapered adapter can be provided that can alternatively be mounted on the tapered bushing to threadably connect a fan clutch such that the fan clutch is operatively connected between the fan and the motor in a variable-drive configuration instead. The rotatable assembly can include features to removably mechanically secure the assembly to both input and output components in a drivetrain while further allowing for extraction and separation of the tapered adapter from the tapered bushing, for instance. The rotatable assembly allows for fully-variable output speed control by using a variable-speed clutch in combination with an essentially single-speed electric motor without the need for a variable frequency drive (VFD). The tapered adapter allows for relatively easy assembly and disassembly of the drivetrain, using a relatively small number of parts. The tapered adapter and adapter kit also provide a sturdy structure for torque transmission. A clutch having a threaded input attachment mechanism can therefore be easily engaged with a motor that lacks threading on its output shaft. Additional features and benefits of the present invention will be appreciated by persons of ordinary skill in the art in light of the entirety of the present disclosure, including the accompanying figures.

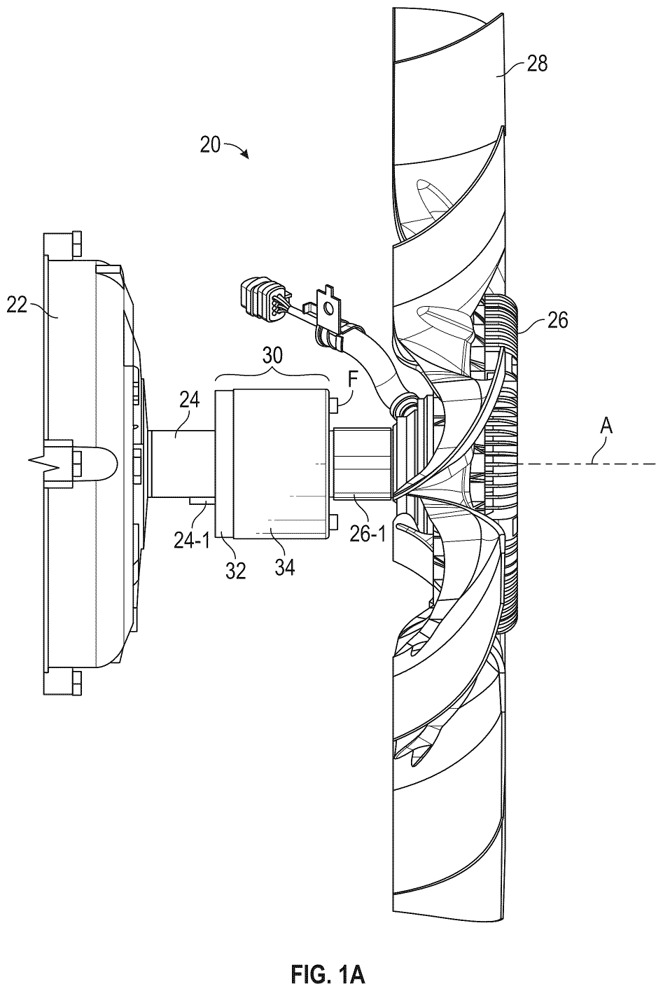

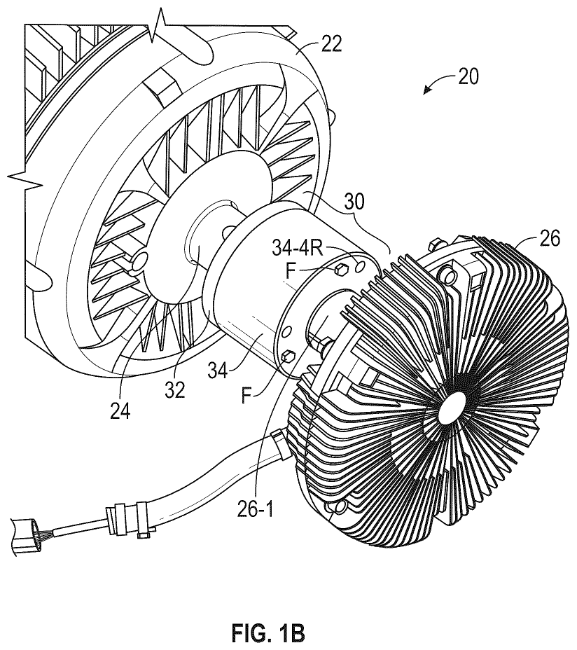

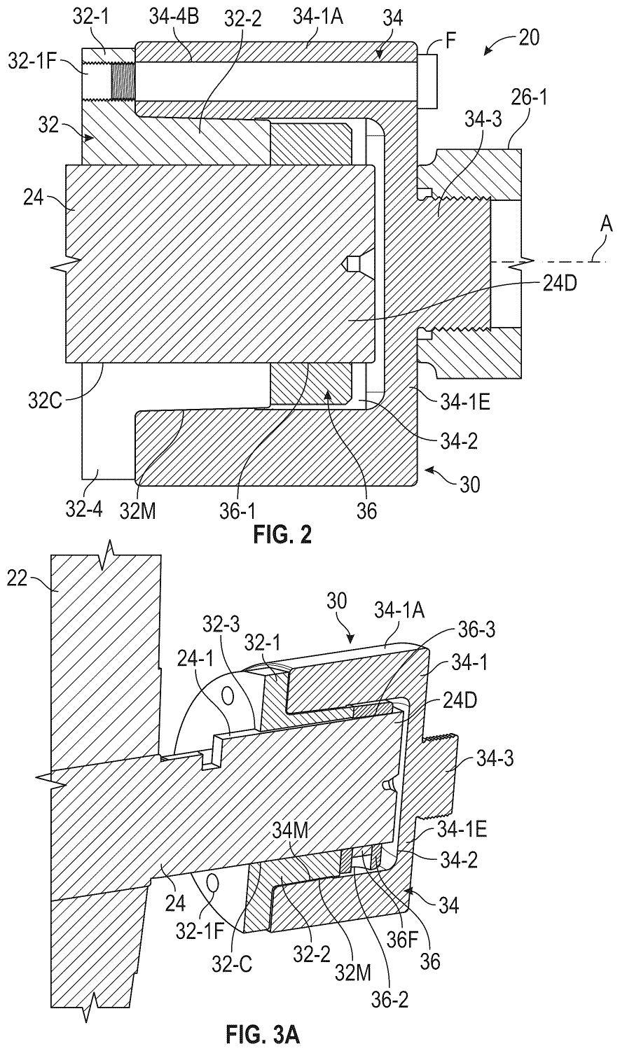

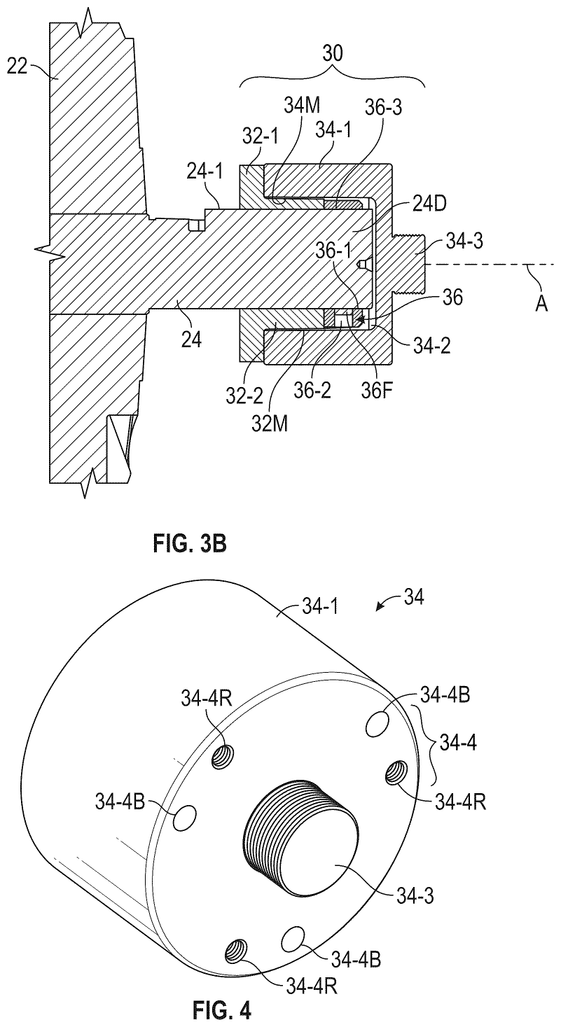

FIG. 1A is a side elevation view of a rotatable assembly 20. FIG. 1B is a front perspective view and FIG. 2 is a cross-sectional view of portions of the rotatable assembly 20. FIG. 3A is a cross-sectional perspective view and FIG. 3B is another cross-sectional view of the portion of the rotatable assembly 20, taken at a different sectional plane than FIG. 2. As shown in the illustrated embodiment, the rotatable assembly 20 includes a motor 22 with an output shaft 24, a clutch 26, a fan 28, and an adapter kit 30. The fan 28 is not shown in FIGS. 2-3B, and the clutch 26 is not shown in FIGS. 3A and 3B.

The motor 22 is operable to provide a torque output via the output shaft 24. In the illustrated embodiment, the motor 22 is configured as an electric motor. In some embodiments, the motor can be an alternating current (AC) electric motor that operates at an essentially constant speed, that is, the motor can be an AC electric motor without a VFD such that a torque output is generated at only a single speed when the motor is energized. In some embodiments, the motor 22 is configured to operate unidirectionally, that is, to rotate only in a single rotational direction when generating an output torque. It should be noted that in sectional views the interior of the motor 22 is shown as if solid, without details of internal components, for simplicity. In general, possible configurations of suitable motors, such as electric motors, are well known, making detailed explanation here unnecessary.

Torque output from the motor 22 can selectively rotate the output shaft 24 about an axis of rotation A. The output shaft 24 can be an integral part of the motor 22, in some embodiments, such as a shaft that carries a winding or permanent magnets when the motor 22 Is an electric motor. In alternate embodiments, the output shaft 24 can be a separate shaft engaged with the motor 22, such as being configured as an extender shaft or auxiliary shaft engaged with another shaft of the motor 22 or the like. Moreover, it is possible for additional drivetrain components to be positioned between the motor 22 and the output shaft 24 in some further embodiments. The output shaft 24 can include a key (or spline) 24-1, as shown in FIGS. 3A and 3B, for example.

The clutch 26 can be an electrically-controlled fully-variable clutch with a mounting connection 26-1. In the illustrated embodiment, the clutch 26 is a variable-speed electrically-controlled viscous clutch with a center shaft input via the mounting connection 26-1. Such clutches are well known. The clutch 26 allows an input torque to be selectively controlled so as to output a torque at a desired output speed, from approximately 0 to 100% of an input speed (e.g., the input speed of the output shaft 24). Torque output from the clutch 26 is delivered to the fan 28 or another output device engaged to the clutch 26, and selective control of the output speed of the clutch 26 can variably control the rotational speed of the fan 28 or other output device even where the output speed of the motor 22 is essentially fixed at a single speed. In some embodiments, a hub of the fan 28 can be secured to the clutch 26 on threaded studs in a rotationally fixed manner, or in any other suitable manner. In the illustrated embodiment, the mounting connection 26-1 is a female threaded connection that accepts a torque input to the clutch 26 at a center of the clutch, aligned with the axis of rotation A. In further embodiments, the mounting connection 26-1 could instead be configured with a male thread or alternatively with another type of mechanical connection.

In the illustrated embodiment, the adapter kit 30 includes a tapered bushing 32, a tapered adapter 34, a bushing lock 36, and suitable fasteners (not all specifically shown). The tapered bushing 32 can include a flange 32-1 and a sleeve portion 32-2 with a central opening 32C and a tapered mating surface 32M. The flange 32-1 can extend radially outward from the axially-extending sleeve portion 32-2, and in the illustrated embodiment is located at a rear end of the sleeve portion 32-2. The flange 32-1 in the illustrated embodiment includes suitable holes 32-1F to attach the tapered bushing 32 to the tapered adapter 34 with suitable mechanical fasteners F (in FIG. 2, one of the fasteners F is shown without hatching, for simplicity). The holes 32-1F can be threaded. In some embodiments, the flange 32-1 can include additional holes used to disengage another component from the tapered bushing 32. The central opening 32C allows the output shaft 24 to pass into or through the tapered bushing 32, radially retains the tapered bushing 32 on the output shaft 24. Further, a keyway 32-3 can be provided along the central opening 32C to accept the key (or spline) 24-1 of the output shaft 24, to rotationally fix the tapered bushing 32 relative to the output shaft 24 to facilitate torque transmission between the output shaft 24 and the tapered bushing 32 of the adapter kit 30. The tapered mating surface 32M of the sleeve portion 32-2 is frusto-conical and faces radially outward, and can accept the tapered adapter 34 or, alternatively, accept a fan or other output component (as explained later in the present disclosure). In some embodiments, the tapered bushing 32 can further include a split 32-4 (see FIG. 2), which can pass generally axially along the entire tapered bushing 32 through both the flange 32-1 and the sleeve portion 32-2 as well as the tapered mating surface 32M, that circumferentially splits the tapered bushing to facilitate a clamped attachment, through a slight reduction in a diameter of the central opening 32C under loading, in the manner of a quick disconnect (QD) bushing.

The tapered bushing 32 can be axially fixed on the output shaft (at least in part) by the bushing lock 36. In the illustrated embodiment, as shown in FIGS. 3A and 3B for example, the bushing lock 36 is generally annular with a central opening 36-1 extending axially and mountable on the output shaft 24 and utilizes a fastener hole 36-2 oriented substantially radially and extending entirely through the bushing lock 36 in substantially the radial direction (that is, extending in a different direction than the central opening 36-1 and being open at opposite inner and outer sides) in which a fastener 36F such as a threaded fastener like a set screw can be engaged with the bushing lock 36 and against the output shaft 24 (e.g., in a frictional engagement against an outer surface of the output shaft 24). In some embodiments, the bushing lock 36 can be unsplit in the circumferential direction, aside from the fastener hole 36-2. Moreover, in the illustrated embodiment, the bushing lock 36 is located past a distal end of the sleeve portion 32-2, opposite the flange 32-1, such that the bushing lock 36 can physically obstruct axial movement of the tapered bushing 32 (for instance, through direct contact at an end of the sleeve portion 32-2) in a forward direction toward the bushing lock 36. Additionally, in the illustrated embodiment the bushing lock 36 includes a keyway 36-3 (see FIGS. 3A and 3B), which can accommodate the key 24-1 of the output shaft 24. However, in further embodiments the bushing lock 36 could be secured to the output shaft 24 in another suitable manner.

The tapered adapter 34 includes a hub body 34-1, an interior cavity 34-2, a tapered mating surface 34M, and a threaded shaft 34-3. In some embodiments, the tapered adapter 34 can be made as a single monolithic picco. The interior cavity 34-2 is formed in the hub body 34-1, at a center of the hub body 34-1, with an open face in a rearward direction as shown in the illustrated embodiment. The tapered mating surface 34M can be a frusto-conical surface located on the hub body 34-1 along the interior cavity 34-2 facing radially inward. In that sense, the hub body 34-1 has a cup-like shape in the illustrated embodiment, with an axially-extending portion 34-1A having a generally cylindrical sleeve-like shape as well as a radially-extending and substantially planar end face portion 34-1E, which can be located at a distal end of the axially-extending portion 34-1A. In the illustrated embodiment, the interior cavity 34-2 is bounded by both the axially-extending portion 34-1A and the end face portion 34-1E, and is open at a rear end opposite the end face portion 34-1E. Portions of the output shaft 24 and the tapered bushing 32, as well as the some or all of the bushing lock 36, are positioned inside the interior cavity 34-2 of the hub body 34-1 when the adapter kit 30 is fully assembled and engaged in the rotatable assembly 20. In particular, a distal end 24E of the output shaft 24 can be positioned inside the interior cavity 34-2 when fully assembled. The geometry of the interior cavity 34-2 allows clearance for any features other than the tapered surface 32-1 of the tapered bushing 32 itself, e.g., the output shaft 24, means for locking the tapered bushing 32 in place axially, etc. For instance, in some embodiments, the interior cavity 34-2 can have a substantially cylindrical shape and can have an axial length that is at long or longer than the combined axial lengths of the sleeve portion 32-2 and the bushing lock 36. In the illustrated embodiment, the tapered adapter 34 is continuous and unsplit in the circumferential direction, which can facilitate applying a wedge load to clamp the tapered bushing 32 on the output shaft 24.

The tapered mating surface 34M of the tapered adapter 34 can mate with the corresponding tapered mating surface 32M of the tapered bushing 32, as shown in FIGS. 2 to 3B, for instance. Engagement of the tapered mating surface 32M of the tapered bushing 32 and the tapered mating surface 34M of the tapered adapter 34 radially retains the tapered adapter 34 relative to the output shaft 24 and the tapered bushing 32, when fully assembled. In some embodiments, engagement of the tapered mating surface 32M of the tapered bushing 32 with the tapered mating surface 34M of the tapered adapter 34 applies a clamping force on the tapered bushing 32, which provides frictional resistance against axial movement of the tapered bushing 32 and helps to axially retain the tapered bushing on the output shaft 24. Thus, a friction fit between the tapered mating surfaces 32M and 34M can transmit torque between the tapered bushing 32 and the tapered adapter 34 and can rotationally fix the tapered bushing 32 and the tapered adapter 34 together. In some embodiments that utilize the fan 28 and in which the motor 22 is configured for unidirectional rotation, rotation of the fan 28 to generate airflows tends to exert an axial force on drivetrain components of the kit 30 in the forward direction, acting as a tensile force on the bushing lock 36, while the unidirectional configuration of the motor 22 means that there is no significant axial loading in the rearward direction on those same components, meaning a relatively small frictional force is sufficient to retain the tapered bushing 32 on the output shaft 24 against rearward axial movement. If additional axial retention capability is desired, such as for use with a bidirectional motor, then an additional bushing lock could be provided at the rear side of the tapered bushing 32 (e.g., adjacent to the flange 32-1) as well to provide enhanced axial retention.

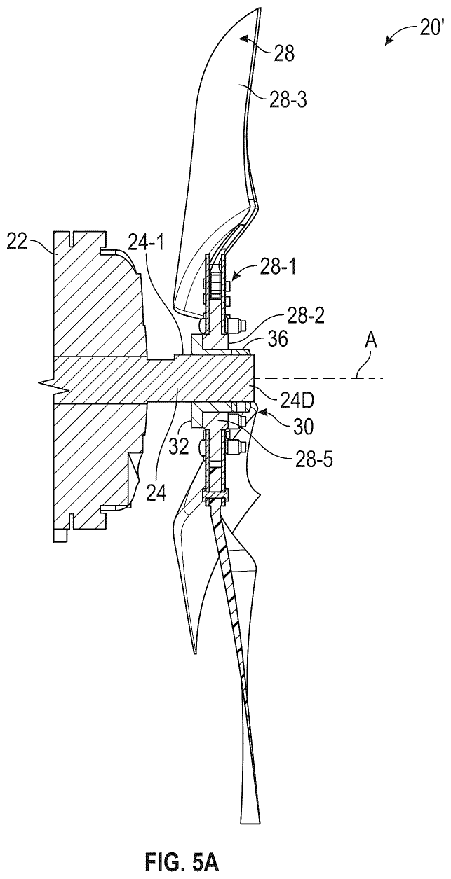

Additionally, as shown in FIG. 4, which is a perspective view the tapered adapter 34 shown in isolation, the tapered adapter 34 has multiple sets of holes 34-4-including a set of clearance holes 34-4B to secure the tapered adapter 34 to the tapered bushing 32 with the fasteners F and another set of holes 34-4R to aid with removing the tapered adapter 34 from the tapered bushing 32. In some embodiments, these sets of holes 34-4 can generally each be located at the end face portion 34-1E of the hub body 34-1 radially outward from interior cavity 34-2. In the illustrated embodiment (see FIG. 4), the tapered adapter 34 includes three threaded holes 34-4R arranged axially into which a user can drive a threaded fastener (not shown), applying a force pushing against the flange 32-1 of the tapered bushing 32 in generally the axial direction, in order to help separate the tapered adapter 34 from the tapered bushing 32 and disengage their respective tapered mating surfaces 34M and 32M. The holes 34-4R can be arranged so as to not align with any holes in the flange 32-1 of the tapered bushing 32. Additionally, the illustrated embodiment of the tapered adapter 34 includes three non-threaded clearance holes 34-4B arranged axially, which can accept the fasteners F (e.g., threaded bolts) to secure the tapered adapter 34 to the tapered bushing 32, such as through corresponding fastener holes 32-1F in the flange 32-1 of the tapered bushing 32. The holes 34-4B and the holes 32-1F can be arranged circumferentially (that is, clocked) so as to align with each other when the respective tapered mating surfaces 34M and 32M of the tapered adapter 34 and the tapered bushing 32 are engaged with each other. In the illustrated embodiment, the holes 34-4B and 34-4R are arranged in pairs, with each pair (and each individual holes 34-4B or 34-4R of a given type) spaced from adjacent ones by approximately 120°. In further embodiments, a different number and/or arrangement of the holes 34-4B and 34-4R can be provided, and the holes 34-4R can be omitted entirely in some embodiments. Engagement of fasteners between the tapered bushing 32 and the tapered adapter 34 through the holes 34-4B can rotationally fix the tapered bushing 32 and the tapered adapter 34 together and help allow torque to be transmitted therebetween.

The threaded shaft 34-3 of the tapered adapter 34 extends from the hub body 34-1. In the illustrated embodiment, the threaded shaft 34-3 extends axially forward from a center of the end face portion 34-1E of the hub body 34-1, opposite the interior cavity 34-2 that faces rearward. While the illustrated embodiment of the threaded shaft 34-3 has exterior male threads, in alternate embodiments interior female threads could be provided instead, depending on the configuration of the device to which the kit 30 will be attached (e.g., the mounting connection 26-1 of the clutch 26). When fully installed in a drivetrain, the threaded shaft 34-3 of the tapered adapter 34 is aligned with an axis of rotation A of the rotatable assembly 20, which is also aligned with the output shaft 24. The tapered adapter 34 should be made of a similar-strength material as that of the mounting connection 26-1 to the clutch 26, such as in embodiments in which the mounting connection 26-1 is made of steel and the tapered adapter 34 is made of cast iron or steel. The thread turn of the threaded shaft 34-3 must be opposite to the intended rotation direction of the output shaft 24 in order to allow the clutch 26 to rotate without coming loose from the tapered adapter 34. In some embodiments, the threaded shaft 34-3 can be the only portion of the threaded adapter 34 that has threads that encircle the axis of rotation A (the threaded holes 34-4R each being located only at one side of the axis of rotation A, for instance).

When fully assembled to provide a drivetrain that permits torque transmission between the motor 22 and the fan 28, the rotatable assembly 20 can include at least some of the components of the kit 30 positioned axially in between the motor 22 and the fan 28, such as on the output shaft 24 and engaged generally rearward of the clutch 26. In such an arrangement, the axial length of the drivetrain of the rotatable assembly 20 is kept relatively short, with the components of the kit 30 and the clutch 26 adding only a small amount of axial length to the overall rotatable assembly 20 beyond the distal end 24D of the output shaft.

One advantage of the disclosed adapter kit 30 is simply being able to use a viscous clutch 26 with a simple electric motor 22, eliminating the need for a variable frequency drive (VFD) while still achieving fully-variable output (e.g., fan output) speed control. Aside from that, however, is the need for less parts to do so. The disclosed tapered adapter 34 incorporates two components into one—the tapered component (e.g., the tapered mating surface 34M) to mate to the tapered bushing 32 and a hub part (e.g., the hub body 34-1 and the threaded shaft 34-3) that attaches to the tapered bushing 32 in order to mount it to the clutch 26.

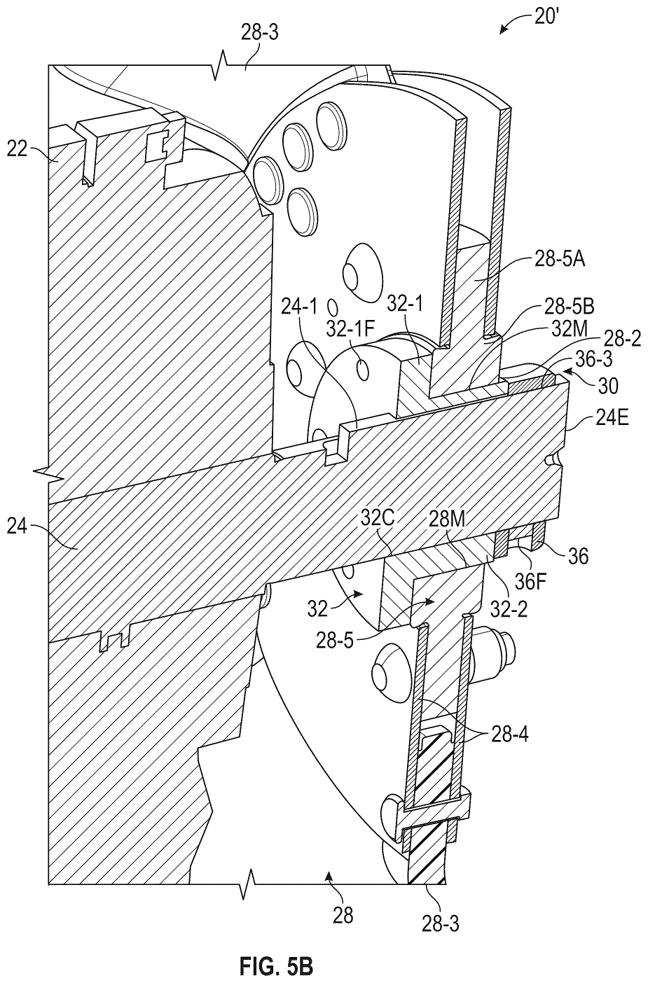

FIGS. 5A and 5B are cross-sectional views of an alternate embodiment of a rotatable assembly 20′ with a directly-driven configuration. As noted above, the adapter kit 30 allows the fan 28 (or other output device) to be directly driven by the motor 22, without the need for a clutch in the drivetrain that links the motor 22 and the fan 28 (or other output device). For instance, if the motor 22 includes a VFD, the motor 22 can already variably control output speed and thus the rotational speed of the fan 28 or the like. As shown in FIGS. 5A and 5B, the tapered bushing 32 is secured to the output shaft 24 at the key 24-1 and held in place with the bushing lock 36, in the same manner described already.

As shown in the illustrated embodiment of FIGS. 5A and 5B, the fan 28 has a hub 28-1 with a tapered mating surface 28M at a central opening 28-2. More specifically, in the illustrated embodiment, the fan 28 includes a plurality of blades 28-3 secured to a pair of hub plates 28-4 (e.g., with suitable fasteners) with a spacer 28-5 positioned at or near the central opening 28-2 and secured to the hub plates 28-4. As shown in the illustrated embodiment, the spacer 28-5 is generally T-shaped, with a first portion 28-5A arranged axially in between the hub plates 28-4 (and secured to the hub plates 28-4 with fasteners) and a second portion 28-5B that defines the central opening 28-2 and the tapered mating surface 28M, which faces radially inward. The second portion 28-5B of the spacer 28-5 can extend radially inward beyond inner diameter edges of the hub plates 28-4 and can be thicker in the axial direction than the first portion 28-5A. The hub 28-1 can thus be directly mounted on the tapered bushing 32, such that the respective mating surfaces 28M and 32M are in contact, and the hub 28-1 secured to the tapered bushing 32 with suitable fasteners. For example, fastener openings (not specifically shown) can be provided in the second portion 28-5B in the same manner as in the tapered adapter 34, in some embodiments, to accept fasteners F that further engage with the holes 32-1F of the tapered bushing 32. In some embodiments, the spacer 28-5 can be the same or similar to those used in the hubs of commercially available HTEC® brand fans from Horton, Inc. (Roseville, MN, USA).

In this alternate embodiment of the rotatable assembly 20′ with a direct-drive configuration, the tapered adapter 34 can be omitted or simply not used; for instance, where the adapter kit 30 including the tapered adapter 34 is initially provided, the tapered adapter 34 can be discarded from the kit 30 and not installed in the drivetrain of the rotatable assembly 20′. In some embodiments, the spacer 28-5 may not be provided within the kit 30 and only provided with the fan 28 if a direct-drive configuration is desired. However, in alternate embodiments, the spacer 28-5 could be included in the kit 30 to allow use if and when desired, and to permit changeovers.

In further embodiments, a tapered mating surface can instead be provided on another output device, such as a pulley or the like, which can mate with the tapered bushing 32 and be secured with suitable fasteners in a similar manner as discussed with respect to the tapered adapter 34 and the spacer 28-5.

In this way, the kit 30 allows components to be selectively installed in the drivetrain of the rotatable assembly 20 to allow for either a direct-drive configuration (without a clutch in the drivetrain, such as shown in FIGS. 5A and 5B) or an indirect-drive configuration (with the variable speed clutch 26 in the drivetrain, such as shown FIGS. 1 to 3B). moreover, the tapered adapter 34 allows for retro-fitting of direct-drive rotatable assemblies 20′ with the clutch 26, which involves replacing the fan hub 28-1 and replacing it with the tapered adapter 34 and then installing the clutch 26 and the fan 28.

It should be noted that the presently-disclosed invention includes an entire rotatable assembly (including the motor, clutch, fan, and adapter kit), an adapter kit by itself (that is usable in a drivetrain of a rotatable assembly), a tapered adapter by itself (that is usable in the adapter kit and/or the rotatable assembly), as well as methods of making and using such components, kits, and assemblies.

### Discussion of Possible Embodiments

A kit for a drivetrain of a rotatable assembly with an output shaft having a key can include a tapered bushing, a tapered adapter, and a bushing lock. The tapered bushing can include a flange, a sleeve portion, a central opening, a keyway located along the central opening, and at least one fastener hole in the flange. The sleeve portion can have a tapered mating surface facing outward. The tapered adapter can include a hub body, an interior cavity, a threaded shaft extending axially forward from a center of an end face portion of the hub body opposite the interior cavity, at least one fastener hole extending substantially axially through the hub body, and a tapered mating surface located along the interior cavity and facing inward. The respective tapered mating surfaces of the tapered bushing and the tapered adapter are configured to be engageable with each other. The at least one fastener hole of the tapered adapter and the at least one fastener hole of the tapered bushing arc configured to align to engage at least one fastener therebetween when the respective tapered mating surfaces of the tapered bushing and the tapered adapter are engaged. The bushing lock can include a bushing lock central opening extending axially, a keyway located along the bushing lock central opening, and a fastener hole extending substantially radially. The bushing lock is configured to be securable on the output shaft adjacent to the tapered bushing.

The kit of the preceding paragraph can optionally include, additionally and/or alternatively, any one or more of the following features, configurations and/or additional components:
a fan hub having a tapered mating surface facing inward, wherein the respective tapered mating surfaces of the fan hub and the tapered adapter are configured to be engageable with each other;
the hub body of the tapered adapter can include an axially-extending portion that is substantially cylindrical; and/or
the end face portion can be substantially planar.

A method of making a rotatable assembly can include: engaging a tapered bushing with an output shaft such that a keyway of the tapered bushing engages a key of the output shaft; engaging a bushing lock on the output shaft adjacent to the tapered bushing such that a keyway of the bushing lock engages the key of the output shaft; securing the bushing lock to the output shaft against axial movement; engaging a tapered adapter with the tapered bushing such that a tapered mating surface of the tapered adapter engages a tapered mating surface of the tapered bushing; and engaging a fastener between the tapered adapter and the tapered bushing.

The method of the preceding paragraph can optionally include, additionally and/or alternatively, any one or more of the following features, configurations and/or additional steps:
the tapered adapter can have an interior cavity, and the bushing lock can be positioned inside the interior cavity of the tapered adapter;
the tapered adapter can further include a hub body with an end face portion;
the tapered adapter can further include a threaded shaft extending axially forward from a center of the end face portion opposite the interior cavity;
engaging a clutch with the threaded shaft of the tapered adapter;
removing a fan having a hub with a tapered mating surface from the tapered bushing.
the step of removing the fan having the hub with tapered mating surface from the tapered bushing can occur prior to the step of engaging the tapered adapter with the tapered bushing; and/or
the step of securing the bushing lock to the output shaft against axial movement can include tightening a fastener engaged with the bushing lock against the output shaft.

A rotatable assembly providing a drivetrain to transmit torque from an output shaft having a key and being rotatable can include a tapered bushing, a tapered adapter, and a bushing lock. The tapered bushing can include a flange, a sleeve portion, a central opening, and a keyway. The sleeve portion of the tapered bushing can have a tapered mating surface facing outward. The output shaft can be arranged in the central opening of the tapered bushing, and the key can be engaged with the keyway. The tapered adapter can include a hub body with an end face portion, an interior cavity, a threaded shaft extending axially forward from a center of the end face portion opposite the interior cavity, and a tapered mating surface located along the interior cavity and facing inward. The respective tapered mating surfaces of the tapered bushing and the tapered adapter can be engaged with each other, and the flange of the tapered bushing and the hub body of the tapered adapter can be secured together with a fastener. The bushing lock can include a bushing lock central opening in which the output shaft is arranged, a keyway engaged with the key, and a fastener hole extending substantially radially with a fastener engaged with the output shaft and the fastener hole in the bushing lock. The bushing lock can be positioned adjacent to the tapered bushing such that the tapered bushing is axially retained on the output shaft.

The rotatable assembly of the preceding paragraph can optionally include, additionally and/or alternatively, any one or more of the following features, configurations and/or additional components:
a clutch secured to the threaded shaft of the tapered adapter such that torque from the output shaft is transmitted to the clutch through the tapered adapter;
a fan engaged with the clutch, with the clutch configured to selectively control rotation of the fan;
a thread turn of the threaded shaft of the tapered adapter can be configured to be opposite to a rotation direction of the output shaft;
the bushing lock can be positioned inside the interior cavity of the tapered adapter;
the tapered adapter can further include at least one threaded hole arranged axially facing the flange of the tapered bushing;
an electric motor;
the electric motor can be configured to have a non-variable output speed;
the electric motor can be configured for unidirectional operation;
the bushing lock can directly contact a distal end of the sleeve portion of the tapered bushing;
the tapered bushing can be split circumferentially by a split; and/or
the tapered adapter can be unsplit in a circumferential direction.

A tapered adapter for a rotatable assembly can include a hub body that is continuous in a circumferential direction, an interior cavity, a threaded shaft, and at least one fastener hole. The hub body can include an axially-extending portion having a cylindrical shape, an end face portion extending radially and located at a distal end of the axially-extending portion, and a tapered mating surface facing inward and having a frusto-conical shape. The interior cavity can be bounded by both the axially-extending portion and the end face portion and can have a rear face that is open opposite the end face portion. The tapered mating surface can be located along the interior cavity. The threaded shaft can extend axially forward from a center of the end face portion of the hub body opposite the interior cavity and aligned with an axis of rotation of the tapered adapter. The at least one fastener hole can extend substantially axially and can pass entirely through the axially-extending portion of the hub body. Optionally, the threaded shaft can be the only portion of the tapered adapter that has threads that encircle the axis of rotation.

### Summation

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, transient alignment or shape variations induced by thermal, rotational or vibrational operational conditions, transitory signal fluctuations, and the like. Moreover, any relative terms or terms of degree used herein should be interpreted to encompass a range that expressly includes the designated quality, characteristic, parameter or value, without variation, as if no qualifying relative term or term of degree were utilized in the given disclosure or recitation.

The word “comprise”, or variations such as “comprises” or “comprising” are used in an open-ended manner herein and should be interpreted to refer to the inclusion of a stated element, feature, or step, or group of elements, features, or steps, but not the exclusion of any other element, feature, or step, or group of elements, features, or steps. Unless further expressly qualified, use of the word “comprise” or variations thereof does not, alone, exclude the present additional, unrecited elements, steps, or groups of elements or steps. Additionally, unless further expressly qualified, the words “a” and “an” as used herein refer to one or more and do not limit the identified element, feature, step, or the like to one and only one. However, use of the words “a” and “an” herein should be interpreted in accordance with and subject to any applicable further limits expressly stated in the context of any particular instance of usage, without extending such context-specific limits to all other uses generally.

Although the present invention has been described with reference to preferred embodiments, workers skilled in the art will recognize that changes may be made in form and detail without departing from the spirit and scope of the invention.

1. A kit for a drivetrain of a rotatable assembly that includes an output shaft having a key, the kit comprising:
a tapered bushing having a flange, a sleeve portion, a central opening, a keyway, and at least one fastener hole in the flange, wherein the sleeve portion has a tapered mating surface facing outward, and wherein the keyway is located along the central opening;
a tapered adapter having a hub body, an interior cavity, a threaded shaft extending axially forward from a center of an end face portion of the hub body opposite the interior cavity, and at least one fastener hole extending substantially axially through the hub body, wherein a tapered mating surface is located along the interior cavity and faces inward, wherein the respective tapered mating surfaces of the tapered bushing and the tapered adapter are configured to be engageable with each other, and wherein the at least one fastener hole of the tapered adapter and the at least one fastener hole of the tapered bushing are configured to align to engage at least one fastener therebetween when the respective tapered mating surfaces of the tapered bushing and the tapered adapter are engaged; and
a bushing lock having a bushing lock central opening extending axially, a keyway located along the bushing lock central opening, and a fastener hole extending substantially radially, wherein the bushing lock is configured to be securable on the output shaft adjacent to the tapered bushing.

2. The kit of claim 1 and further comprising:
a fan hub having a tapered mating surface facing inward, wherein the respective tapered mating surfaces of the fan hub and the tapered adapter are configured to be engageable with each other.

3. The kit of claim 1, wherein the hub body of the tapered adapter includes an axially-extending portion that is substantially cylindrical, and wherein the end face portion is substantially planar.

4. A method of making a rotatable assembly, the method comprising:
engaging a tapered bushing with an output shaft such that a keyway of the tapered bushing engages a key of the output shaft;
engaging a bushing lock on the output shaft adjacent to the tapered bushing such that a keyway of the bushing lock engages the key of the output shaft;
securing the bushing lock to the output shaft against axial movement;
engaging a tapered adapter with the tapered bushing such that a tapered mating surface of the tapered adapter engages a tapered mating surface of the tapered bushing; and
engaging a fastener between the tapered adapter and the tapered bushing.

5. The method of claim 4, wherein the tapered adapter has an interior cavity, and wherein the bushing lock is positioned inside the interior cavity of the tapered adapter.

6. The method of claim 5, wherein the tapered adapter further includes a hub body with an end face portion, and a threaded shaft extending axially forward from a center of the end face portion opposite the interior cavity, the method further comprising:
engaging a clutch with the threaded shaft of the tapered adapter.

7. The method of claim 4 and further comprising:
removing a fan having a hub with a tapered mating surface from the tapered bushing.

8. The method of claim 7, wherein the step of removing the fan having the hub with tapered mating surface from the tapered bushing occurs prior to the step of engaging the tapered adapter with the tapered bushing.

9. The method of claim 4, wherein the step of securing the bushing lock to the output shaft against axial movement comprises tightening a fastener engaged with the bushing lock against the output shaft.

10. A rotatable assembly providing a drivetrain to transmit torque from an output shaft, the output shaft having a key and being rotatable, the rotatable assembly comprising:
a tapered bushing having a flange, a sleeve portion, a central opening, and a keyway, wherein the sleeve portion has a tapered mating surface facing outward, wherein the output shaft is arranged in the central opening of the tapered bushing, and wherein the key is engaged with the keyway;
a tapered adapter having a hub body with an end face portion, an interior cavity, and a threaded shaft extending axially forward from a center of the end face portion opposite the interior cavity, wherein a tapered mating surface is located along the interior cavity and faces inward, wherein the respective tapered mating surfaces of the tapered bushing and the tapered adapter engaged with each other, and wherein the flange of the tapered bushing and the hub body of the tapered adapter are secured together with a fastener; and
a bushing lock having a bushing lock central opening in which the output shaft is arranged, a keyway engaged with the key, and a fastener hole extending substantially radially with a fastener engaged with the output shaft and the fastener hole in the bushing lock, wherein the bushing lock is positioned adjacent to the tapered bushing such that the tapered bushing is axially retained on the output shaft.

11. The rotatable assembly of claim 10 and further comprising:
a clutch secured to the threaded shaft of the tapered adapter such that torque from the output shaft is transmitted to the clutch through the tapered adapter.

12. The rotatable assembly of claim 11 and further comprising:
a fan engaged with the clutch, wherein the clutch is configured to selectively control rotation of the fan.

13. The rotatable assembly of claim 10, wherein a thread turn of the threaded shaft of the tapered adapter is configured to be opposite to a rotation direction of the output shaft.

14. The rotatable assembly of claim 10, wherein the bushing lock is positioned inside the interior cavity of the tapered adapter.

15. The rotatable assembly of claim 10, wherein the tapered adapter further comprises:
at least one threaded hole arranged axially facing the flange of the tapered bushing.

16. The rotatable assembly of claim 10 and further comprising:
an electric motor, wherein the electric motor has a non-variable output speed and is configured for unidirectional operation.

17. The rotatable assembly of claim 10, wherein the bushing lock directly contacts a distal end of the sleeve portion of the tapered bushing.

18. The rotatable assembly of claim 10, wherein the tapered bushing is split circumferentially by a split, and wherein the tapered adapter is unsplit in a circumferential direction.

19. A tapered adapter for a rotatable assembly, the tapered adapter comprising:
a hub body that is continuous in a circumferential direction includes:
an axially-extending portion having a cylindrical shape;
an end face portion extending radially and located at a distal end of the axially-extending portion; and
a tapered mating surface facing inward and having a frusto-conical shape;
an interior cavity, wherein the interior cavity is bounded by both the axially-extending portion and the end face portion and has a rear face that is open opposite the end face portion, and wherein the tapered mating surface is located along the interior cavity;
a threaded shaft extending axially forward from a center of the end face portion of the hub body opposite the interior cavity and aligned with an axis of rotation of the tapered adapter, wherein the threaded shaft is the only portion of the tapered adapter that has threads that encircle the axis of rotation; and
at least one fastener hole extending substantially axially and passing entirely through the axially-extending portion of the hub body.

20. The tapered adapter of claim 19 and further comprising:
at least one threaded hole arranged axially in the hub body and passing entirely through the axially-extending portion of the hub body, the at least one threaded hole each located radially outward from the interior cavity at the end face portion,
wherein the at least one fastener hole comprises at least three fastener holes circumferentially spaced from each other and each located radially outward from the interior cavity at the end face portion, and
wherein at least an axially forward-facing part of the end face portion adjacent to the threaded shaft is substantially planar.
